(19) United States
(12) Patent Application Publication
(10) Pub. No.: US 2019/0136851 A1
(43) Pub. Date: May 9, 2019

(54) PUMP DEVICE

(71) Applicant: KYB Corporation, Tokyo (JP)

(72) Inventor: Yuki SAKAI, Kanagawa (JP)

(73) Assignee: KYB Corporation, Tokyo (JP)

(21) Appl. No.: 16/307,353

(22) PCT Filed: May 23, 2017
(86) PCT No.: PCT/JP2017/019284

§ 371 Date: Dec. 5, 2018

(30) Foreign Application Priority Data
Jun. 8, 2016 (JP) 2016-114427

(51) Int. Cl. F04B 49/06; F15B 11/02; F04B 49/08; F04B 27/18

(52) U.S. Cl. CPC F04B 49/06; F15B 11/02; F15B 2211/6652; F04B 27/18; F15B 2211/20546; F04B 49/08

(57) ABSTRACT

A pump device includes a tilting actuator for controlling a tilting angle of a swash plate in a variable capacity first pump, a regulator for adjusting a control pressure in accordance with a front-rear differential pressure of a control valve, and a control actuator for driving the regulator in accordance with a front-rear differential pressure of a resistor to which the working oil discharged from a fixed capacity second pump is led, and in the control actuator, a pressure receiving area of a control piston on which an auxiliary pressure against an upstream pressure of the resistor acts is set so that an auxiliary driving force corresponds to a lowered amount of a differential-pressure driving force with switching of a rotation speed of a drive source from a first rotation speed to a second rotation speed.

### TECHNICAL FIELD

The present invention relates a pump device.

### BACKGROUND ART

JP2008-291731A discloses a pump device including a first pump whose pump discharge amount supplied to a hydraulic circuit in accordance with a tilting angle of a swash plate is variable, a tilting actuator which reduces a tilting angle of the swash plate in accordance with a rise in a supplied control pressure, a regulator for adjusting the control pressure in accordance with a load pressure of the hydraulic circuit, a second pump in conjunction with the first pump, an orifice interposed in an discharge circuit of the second pump, and an actuator driven so as to reduce the control pressure adjusted by the regulator in accordance with the rise of a front-rear differential pressure of the orifice.

### SUMMARY OF INVENTION

In the pump device subjected to load sensing control as disclosed in JP2008-291731A, when a rotation speed of a drive source for driving the first and second pumps lowers, an discharge flow of the second pump is reduced, and a front-rear differential pressure of the orifice (resistor) lowers. As a result, since the actuator (control actuator) drives the regulator so that the control pressure increases, the tilting actuator reduces the tilting angle of the swash plate, and the discharge amount of the first pump is reduced. As described above, in a pump discharge amount control device of JP2008-291731A, when the rotation speed of the drive source lowers, the discharge flow of the first pump is reduced, and a speed of the driving actuator for driving a driving subject lowers.

Here, there can be a case where the driving speed of the driving actuator required for the rotation speed of the drive source is different such as a case where a worker is different, for example. That is, the pump device is required to have both functions for lowering the driving speed in accordance with lowering of the rotation speed and for maintaining the driving speed almost without lowering regardless of the lowering of the rotation speed in some cases.

The present invention has an object to provide a pump device which can change a changing rate of the discharge flow with respect to a change in the rotation speed.

According to one aspect of the present invention, a pump device for supplying a working fluid to a drive actuator for driving a drive subject through a control valve, includes: a variable capacity first pump configured to supply the working fluid to the drive actuator, the first pump having a discharge capacity that varies in accordance with a tilt angle of a swash plate; a tilt actuator configured to control the tilt angle of the swash plate of the first pump in accordance with a control pressure supplied thereto; a regulator configured to regulate the control pressure by a control spool moving in accordance with a front-rear differential pressure on an upstream side and a pressure on a downstream side of the control valve; a fixed capacity second pump configured to be driven by an identical drive source to that of the first pump; a resistor provided in a pump passage through which the working fluid discharged from the second pump is led; a control actuator configured to operate in accordance with a front-rear differential pressure of the resistor so as to drive the regulator to reduce the control pressure in response to an increase in the front-rear differential pressure of the resistor; an auxiliary passage configured to lead an auxiliary pressure to the control actuator, the auxiliary pressure acting on the control actuator against either an upstream side pressure or a downstream side pressure of the resistor; a switch valve configured to switch between a state in which the auxiliary pressure is supplied to the control actuator through the auxiliary passage and a state in which the auxiliary pressure is shut off; and a controller configured to switch the switch valve and to switch a rotation speed of the drive source between a first rotation speed and a second rotation speed smaller than the first rotation speed. The control actuator has a control piston configured to be moved so that a differential-pressure driving force generated by receiving the front-rear differential pressure of the resistor and an auxiliary driving force generated by receiving the auxiliary pressure are balanced. A pressure receiving area of the control piston on which the auxiliary pressure acts is set so that the auxiliary driving force corresponds to a change amount of the differential-pressure driving force accompanying switching of the rotation speed of the drive source between the first rotation speed and the second rotation speed.

### BRIEF DESCRIPTION OF DRAWINGS

FIG. 1 is a hydraulic circuit diagram of a hydraulic driving device including a pump device according to a first embodiment of the present invention.

FIG. 2 is a sectional view of the pump device according to the first embodiment of the present invention and illustrates a state where a regulator is at a first position.

FIG. 3 is an enlarged view of an A part in FIG. 2.

FIG. 4 is a sectional view of the pump device according to the first embodiment of the present invention and illustrates a state where the regulator is at a second position.

FIG. 5 is a sectional view of the pump device according to the first embodiment of the present invention when seen from a side surface.

FIG. 6 is a sectional view of a pump device according to a second embodiment of the present invention.

### DESCRIPTION OF EMBODIMENTS

### First Embodiment

Referring to the figures, a pump device 100 according to a first embodiment of the present invention and a hydraulic driving device 1 that includes the pump device 100 will be described.

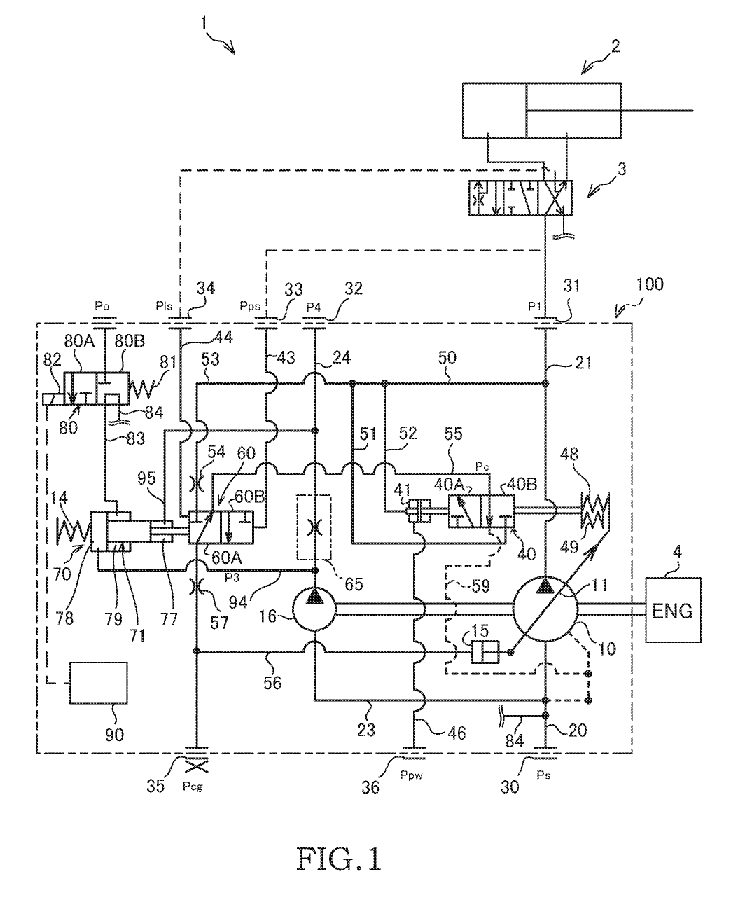

The hydraulic driving device 1 is installed in a hydraulic shovel, for example, in order to drive a drive subject (a boom, an arm, a bucket, or the like). As shown in FIG. 1, the hydraulic driving device 1 includes a hydraulic cylinder 2 serving as a drive actuator that drives the drive subject in accordance with the supply and discharge of working oil, which serves as a working fluid, thereto and therefrom, a control valve 3 that controls a flow of the working oil supplied to and discharged from the hydraulic cylinder 2, and the pump device 100, which serves as a driving oil pressure source for supplying the working oil to the hydraulic cylinder 2 through the control valve 3.

The hydraulic cylinder 2 drives the drive subject by expanding and contracting in response to the working oil that is led thereto from the pump device 100 through the control valve 3. An opening of the control valve 3 is adjusted in response to an operation performed by an operator, whereby the control valve 3 adjusts a flow of the working oil supplied to the hydraulic cylinder 2. In FIG. 1, only one hydraulic cylinder 2 and the control valve 3 for controlling the hydraulic cylinder 2 are shown, and other drive actuators and control valves have been omitted.

The working oil discharged from the pump device 100 is pumped to a pump port 31 through a discharge passage 21, and then led to the hydraulic cylinder 2 through the control valve 3, which is connected to the pump port 31.

The pump device 100 includes a variable capacity first pump 10 for supplying working oil to the hydraulic cylinder 2, a discharge capacity of the first pump 10 being varied in accordance with a tilt angle of a swash plate 11, a tilt actuator 15 that controls the tilt angle of the swash plate 11 of the first pump 10 in accordance with a control pressure Pcg supplied thereto, a regulator (a load sensing regulator) 60 that regulates the control pressure Pcg led to the tilt actuator 15 in accordance with a front-rear differential pressure of the control valve 3, and a horsepower control regulator 40 that regulates a control source pressure Pc led to the regulator 60 in accordance with a discharge pressure P1 of the first pump 10.

A swash plate piston pump, for example, is used as the first pump 10, and the discharge capacity (a pump displacement volume) thereof is adjusted in accordance with the tilt angle of the swash plate 11. It should be noted that the “discharge capacity” denotes an amount of working oil discharged by the first pump 10 per revolution. Further, a “discharge flow”, to be described below, denotes an amount of working oil discharged by the first pump 10 and a second pump 16, to be described below, per unit time.

The first pump 10 is driven by an engine 4 serving as a drive source. The first pump 10 suctions working oil through a suction passage 20 from a tank port 30 connected to a tank (not shown), and discharges the working oil, which is pressurized by a piston (not shown) that reciprocates while following the swash plate 11, into the discharge passage 21. The working oil discharged from the first pump 10 is supplied to the hydraulic cylinder 2 through the control valve 3. Further, a part of the working oil discharged from the first pump 10 is led to a branch passage 50 that bifurcates from the discharge passage 21. The branch passage 50 bifurcates into first to third discharge pressure passages 51, 52, 53, and leads the discharge pressure P1 of the first pump 10 into each thereof.

The first pump 10 includes a cylinder block (not shown) that is driven to rotate by the engine 4, the piston, which reciprocates through a cylinder in the cylinder block so as to discharge the suctioned working oil, the swash plate 11, which is followed by the piston, and horsepower control springs 48, 49 that bias the swash plate 11 in a direction for increasing the tilt angle thereof.

The tilt actuator 15 drives the swash plate 11 against a biasing force of the horsepower control springs 48, 49 of the first pump 10. When the tilt angle of the swash plate 11 is varied by an operation of the tilt actuator 15, a stroke length of the piston that reciprocates while following the swash plate 11 varies, leading to variation in the discharge capacity of the first pump 10. The tilt actuator 15 may be built into the cylinder block of the first pump 10 or provided on the exterior of the cylinder block.

When the control pressure Pcg regulated by the horsepower control regulator 40 and the regulator 60 increases, the tilt actuator 15 executes an expansion operation so as to reduce the tilt angle of the swash plate 11, and as a result, the discharge capacity of the first pump 10 decreases.

The horsepower control regulator 40 is a switch valve having three ports and two positions. A first control pressure passage 55 connected to the regulator 60 is connected to a port on one side of the horsepower control regulator 40. The first discharge pressure passage 51 to which the discharge pressure P1 of the first pump 10 is led and a low pressure passage 59 connected to the tank are connected respectively to two ports on the other side of the horsepower control regulator 40.

The horsepower control regulator 40 includes a spool (not shown) that moves continuously between a high pressure position 40A in which the first control pressure passage 55 communicates with the first discharge pressure passage 51, and a low pressure position 40B in which the first control pressure passage 55 communicates with the low pressure passage 59. The biasing force of the horsepower control springs 48, 49 is applied to one end of the spool of the horsepower control regulator 40. The discharge pressure P1 of the first pump 10, which is led through the second discharge pressure passage 52, acts on the other end of the spool. The spool of the horsepower control regulator 40 moves to a position where the discharge pressure P1 and the biasing force of the horsepower control springs 48, 49 are counterbalanced, thereby varying respective openings of the high pressure position 40A and the low pressure position 40B.

The horsepower control springs 48, 49 are coupled to the spool of the horsepower control regulator 40 at one end, and linked to the swash plate 11 of the first pump 10 at the other end. The horsepower control spring 49 is formed to be shorter than the horsepower control spring 48. The biasing force generated by the horsepower control springs 48, 49 varies according to the tilt angle of the swash plate 11 and the position of the spool of the horsepower control regulator 40. Hence, the biasing force exerted on the swash plate 11 from the horsepower control springs 48, 49 increases in steps in accordance with the tilt angle of the swash plate 11 and the stroke of the spool of the horsepower control regulator 40.

The horsepower control regulator 40 is provided with a horsepower control actuator 41. The horsepower control actuator 41 operates in accordance with a horsepower control signal pressure Ppw that is led thereto from a horsepower control signal pressure port 36 through a horsepower control signal pressure passage 46.

A control system of the hydraulic shovel is switched between a high load mode and a low load mode. The horsepower control signal pressure Ppw is reduced in the high load mode and increased in the low load mode. When the horsepower control signal pressure Ppw is increased in the low load mode, the spool of the horsepower control regulator 40 moves in a direction for switching to the high pressure position 40A. Accordingly, the control source pressure Pc increases, leading to a reduction in the load of the first pump 10.

The regulator 60 is a switch valve having three ports and two positions. The third discharge pressure passage 53 to which the discharge pressure P1 of the first pump 10 is led and the first control pressure passage 55 connected to the horsepower control regulator 40 are connected respectively to two ports on one side of the regulator 60. A second control pressure passage 56 that leads the control pressure Pcg to the tilt actuator 15 is connected to a port on the other side of the regulator 60. A throttle 57 is interposed in the second control pressure passage 56, and pressure variation in the control pressure Pcg led to the tilt actuator 15 is mitigated by the throttle 57. Further, a throttle 54 is interposed in the third discharge pressure passage 53, and pressure variation in the discharge pressure P1 led to the regulator 60 is mitigated by the throttle 54.

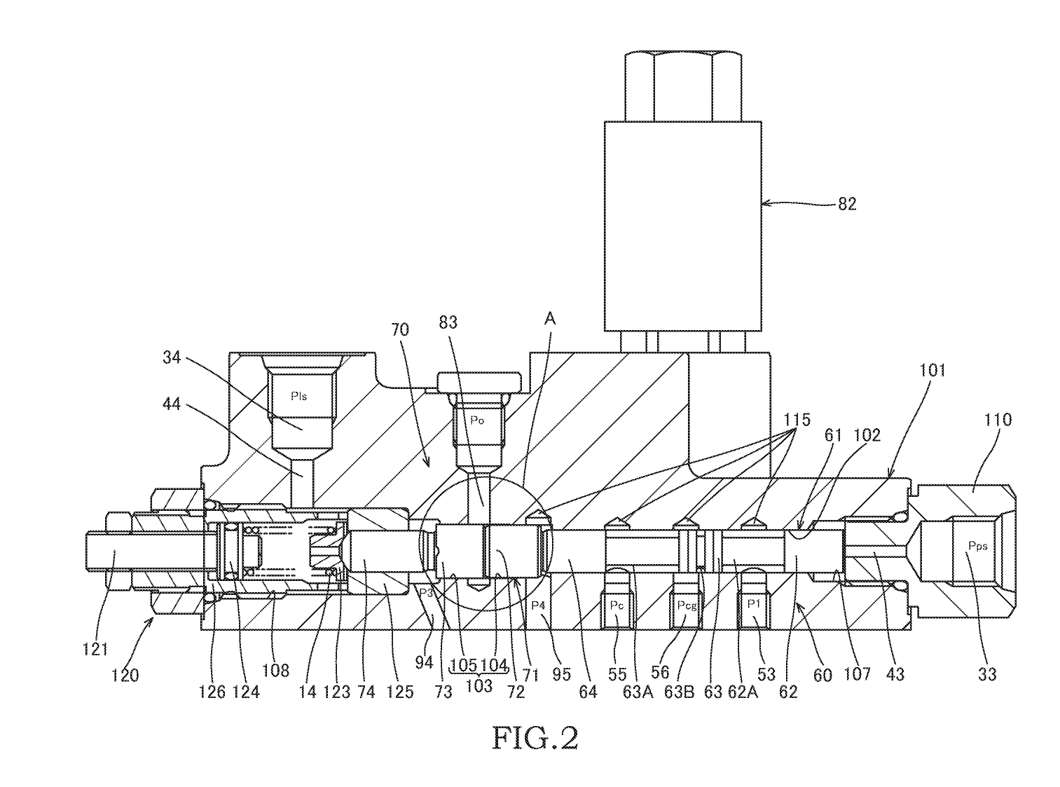

The regulator 60 includes a control spool 61 (see FIG. 2) that moves continuously between a first position 60A in which the first control pressure passage 55 communicates with the second control pressure passage 56, and a second position 60B in which the third discharge pressure passage 53 communicates with the second control pressure passage 56.

An upstream signal pressure Pps generated on an upstream side of the control valve 3 on the basis of the discharge pressure P1 of the first pump 10 is led to one end of the control spool 61 of the regulator 60 from a signal port 33 through a first signal passage 43. A downstream signal pressure Pls generated on a downstream side of the control valve 3 on the basis of a load pressure of the hydraulic cylinder 2 is led to another end of the spool of the regulator 60 from a signal port 34 through a second signal passage 44. Further, a biasing force of an LS spring 14 that biases the regulator 60 in a direction for switching to the first position 60A is exerted on the other end of the control spool 61 of the regulator 60. Specific constitution of the regulator 60 will be described later in detail.

The pump device 100 also includes the second pump 16, which is a fixed capacity pump and is driven by the same drive source as the first pump 10, a resistor 65 interposed in a pump passage 24 through which the working oil discharged from the second pump 16 is led, a control actuator 70 that adjusts the control pressure Pcg by driving the regulator 60 in accordance with a front-rear differential pressure (P3−P4) of the resistor 65, an auxiliary passage 83 that leads an auxiliary pressure Po, which acts against a pressure P3 on an upstream side of the resistor 65, to the control actuator 70, a switch valve 80 that is provided in the auxiliary passage 83 so as to selectively switch between connecting and shutting off the auxiliary passage 83, and a controller 90 switching the switch valve 80 in accordance with an operation input of the worker and capable of changing an engine rotation speed.

The second pump 16 is provided side by side with the first pump 10, and is driven by the engine 4 together with the first pump 10. A gear pump, for example, is used as the second pump 16,

The second pump 16 suctions working oil through a branch suction passage 23 bifurcating from the suction passage 20, and discharges the pressurized working oil into the pump passage 24. The working oil discharged from the second pump 16 is pumped to a pump port 32 through the pump passage 24, and supplied to a hydraulic driving unit or the like for switching the control valve 3 through a passage (not shown) connected to the pump port 32.

The resistor 65 is a fixed throttle interposed in the pump passage 24. The resistor 65 may have a relief valve or a check valve provided in parallel in addition to the fixed throttle.

The control actuator 70 has a control piston 71 moving to a position where a pressure on an upstream side of the resistor 65 (hereinafter referred to as an “upstream pressure”) P3, a pressure on a downstream side (hereinafter referred to as a “downstream pressure”) P4, and the auxiliary pressure Po are balanced and drives the regulator 60 in accordance with these pressures. Specific constitution of the control actuator 70 will be described later in detail.

The auxiliary passage 83 leads the auxiliary pressure Po supplied from outside of the pump device 100 to the control actuator 70. The auxiliary pressure Po is generated by pressure adjustment of the working oil discharged from the second pump 16 by an adjustment mechanism located outside the pump device 100, for example.

The switch valve 80 is a solenoid switch valve (an ON-OFF valve) having two ports and two positions. The switch valve 80 has a communication position 80A where the auxiliary passage 83 is allowed to communicate and the auxiliary pressure Po is supplied to the control actuator 70 and a shutoff position 80B where the supply of the auxiliary pressure Po to the control actuator 70 through the auxiliary passage 83 is shut off.

The controller 90 is constituted by a microcomputer having a CPU (a central processing unit), a ROM (a read-only memory), a RAM (a random access memory), and an I/O interface (an input/output interface). The RAM stores data used during processing executed by the CPU. A control program of the CPU and so on are stored in the ROM in advance. The I/O interface is used to input and output information into and from devices connected thereto. The controller 90 may be constituted by a plurality of microcomputers. The controller 85 is programmed to be capable of at least executing processing required to implement control according to this embodiment and modified examples thereof. It should be noted that the controller 90 may be constituted by a single device, or divided into a plurality of devices such that the processing of each of embodiments is executed discretely by the plurality of devices.

When a current is supplied to the solenoid 82 from the controller 90, the switch valve 80 takes the communication position 80A, whereby the auxiliary passage 83 opens. As a result, the auxiliary pressure Po is led into the control actuator 70 through the auxiliary passage 83.

Conversely, when energization of the solenoid 82 from the controller 90 is shut off, the switch valve 80 is caused to take the shutoff position 80B by the biasing force of the biasing spring 81, whereby the auxiliary passage 83 is shut off. As a result, supply of the auxiliary pressure Po to the control actuator 70 is shut off, and the third pressure chamber 79, which will be described later, of the control actuator 70 communicates with the tank so as to shift to a tank pressure.

The auxiliary pressure Po is led selectively to the control actuator 70 from the auxiliary passage 83 in addition the front-rear differential pressure (P3−P4) of the resistor 65, and therefore a control piston 71 moves to a position where the front-rear differential pressure (P3−P4) of the resistor 65 and the auxiliary pressure Po are counterbalanced. In accordance therewith, the control actuator 70 exerts a driving force on the regulator 60. In other words, the front-rear differential pressure (P3−P4) of the resistor 65 and the auxiliary pressure Po act on the control spool 61 of the regulator 60 as the driving force exerted from the control actuator 70 in addition to an LS differential pressure (Pps−Pls) generated on the front and the rear of the control valve 3, and the biasing force of the LS spring 14 that acts on the other end of the control spool 61. As a result, the spool of the regulator 60 moves to a position where the LS differential pressure (Pps−Pls), the front-rear differential pressure (P3−P4) of the resistor 65, the auxiliary pressure Po, and the biasing force of the LS spring 14 are counterbalanced, thereby varying the respective openings of the first position 60A and the second position 60B of the regulator 60.

In the following, by referring to FIGS. 2 to 5, specific constitutions of the regulator 60, the control actuator 70, and the switch valve 80 will be described in detail.

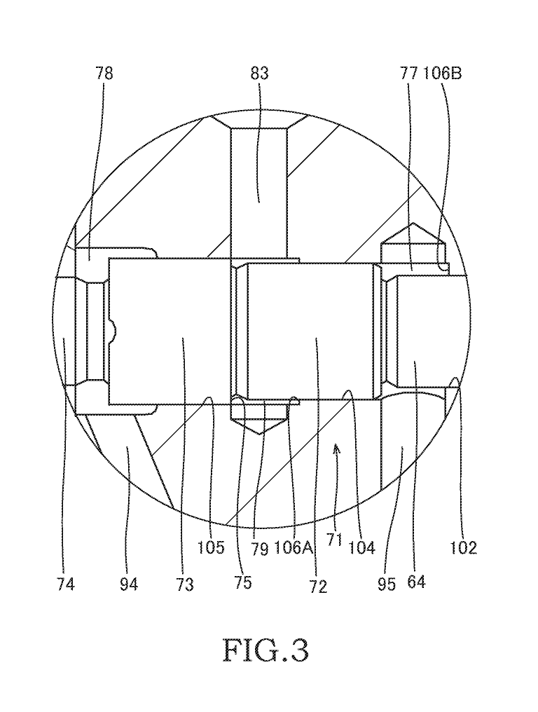

As illustrated in FIGS. 2 and 3, the regulator 60, the control actuator 70, and the switch valve 80 are provided in a common housing 101, respectively.

In the housing 101, a spool hole 102 accommodating the control spool 61 of the regulator 60 and a cylinder hole 103 through which the control piston 71 of the control actuator 70 are slidably inserted are formed coaxially. Moreover, in the housing 101, a first pilot chamber 107 to which the upstream signal pressure Pps of the control valve 3 is led and a second pilot chamber 108 to which the downstream signal pressure Pls of the control valve 3 is led are further formed. The second pilot chamber 108, the cylinder hole 103, the spool hole 102, and the first pilot chamber 107 are provided side by side in this order in the axial direction.

The control spool 61 of the regulator 60 and the control piston 71 of the control actuator 70 are integrally formed side by side coaxially. Not limited to that, the control spool 61 and the control piston 71 may be formed as separate bodies and linked with each other.

The control spool 61 of the regulator 60 is movably inserted into the spool hole 102 in the axial direction. The control spool 61 has first, second, and third land portions 62, 63, and 64 juxtaposed in the axial direction and sliding in the spool hole 102. The first, second, and third land portions 62, 63, and 64 are formed coaxially, respectively. Between the first land portion 62 and the second land portion 63, a first annular groove 62A opened on an outer peripheral surface of the control spool 61 is formed. Between the second land portion 63 and the third land portion 64, a second annular groove 63A opened on an outer peripheral surface of the control spool 61 is formed. Moreover, on the second land portion 63, a third annular groove 63B allowing the second control pressure passage 56 to communicate with an opposing hole 115 which will be described later regardless of a position of the control spool 61 is formed on an outer periphery.

The cylinder hole 103 has, as illustrated in FIGS. 2 and 3, a first cylinder hole 104 having an inner diameter larger than an inner diameter of the spool hole 102 and a second cylinder hole 105 having an inner diameter larger than the inner diameter of the first cylinder hole 104. Between the first cylinder hole 104 and the second cylinder hole 105, a first cylinder stepped portion 106A which is an annular stepped portion is formed. Between the first cylinder hole 104 and the spool hole 102, a second cylinder stepped portion 106B which is an annular stepped portion is formed.

The control piston 71 has a first piston portion 72 connected to the control spool 61 and slidably inserted into the first cylinder hole 104, a second piston portion 73 connected to the first piston portion 72 and slidably inserted into the second cylinder hole 105, a third piston portion 74 connected to the second piston portion 73 on a side opposite to the first piston portion 72 in the axial direction in the second piston portion 73 and formed having an outer diameter smaller than the second piston portion 73, and a piston stepped portion 75 which is an annular stepped portion formed between the first piston portion 72 and the second piston portion 73 (see FIG. 3). The third piston portion 74 is slidably supported by a guide sleeve 125 which will be described later and is accommodated in the second pilot chamber 108.

Inside the cylinder hole 103 is divided into, as illustrated in FIG. 3, a first pressure chamber 77 formed by the control piston 71 between the first piston portion 72 and the second cylinder stepped portion 106B, a second pressure chamber 78 formed between the guide sleeve 125 provided on the second pilot chamber 108 and the second piston portion 73, and a third pressure chamber 79 formed between the second piston portion 73 and the first cylinder stepped portion 106A.

The first pilot chamber 107 communicates with the spool hole 102 and is opened in a surface of the housing 101 as illustrated in FIG. 2. The second pilot chamber 108 communicates with the cylinder hole 103 and is opened in the surface of the housing 101.

The first pilot chamber 107 has its opening portion to the surface of the housing 101 sealed by a first plug 110. On the first plug 110, a signal port 33 for leading the upstream signal pressure Pps of the control valve 3 to the first pilot chamber 107 and a first signal passage 43 are formed.

In the second pilot chamber 108, the LS spring 14, an adjuster 120 for adjusting an biasing force of the LS spring 14, the guide sleeve 125 faced with the cylinder hole 103, and a second plug 126 sealing an opening portion of the second pilot chamber 108 are accommodated.

The adjuster 120 includes an adjuster rod 121 screwed with the second plug 126, a spring receiver 123 mounted on the third piston portion 74 of the control piston 71, and a spring receiver 124 slidably accommodated inside the second plug 126. The coil-shaped LS spring 14 is interposed between the spring receiver 123 and the spring receiver 124 in a compressed manner. By changing a screwing position of the adjuster rod 121, the biasing force of the LS spring 14 is adjusted.

In the housing 101, the signal port 34 on a downstream side to which the downstream signal pressure Pls of the control valve 3 is led and the second signal passage 44 and the auxiliary passage 83 to which the auxiliary pressure Po is led are further formed. To the second pilot chamber 108, the downstream signal pressure Pls is led through the signal port 34 on the downstream side and the second signal passage 44.

Moreover, in the housing 101, the third discharge pressure passage 53 opened in the spool hole 102 from a radial direction and to which the discharge pressure of the first pump 10 is led as an introduction passage for introducing the working oil into the spool hole 102, the second control pressure passage 56 to which the control pressure Pcg to be supplied to the tilting actuator 15 is led, the first control pressure passage 55 communicating with the horsepower control regulator 40, and a downstream pressure passage 95 to which the downstream pressure P4 of the resistor 65 is led are further formed. These passages are also collectively referred to simply as “introduction passages”.

Moreover, at positions facing the openings in each of the introduction passages 53, 55, 56 and 95 by sandwiching a center of the spool hole 102 between them, opposing holes 115 corresponding to each of the introduction passages 53, 55, 56, and 95 are formed. By forming the opposing holes 115, a pressure balance of the working oil acting on the control spool 61 is made favorable, and slidability of the control spool 61 is made favorable.

The upstream signal pressure Pps acts on an end surface in the axial direction of the first land portion 62 of the control spool 61 and exerts a driving force for moving the control spool 61 and the control piston 71 to a left direction in FIG. 2. The downstream signal pressure Pls acts on an end surface in the axial direction of the third piston portion 74 of the control piston 71 in the control actuator 70 directly or through a spring receiver 123 and exerts the driving force for moving the control piston 71 and the control spool 61 in a right direction in the FIG. 2.

A pressure receiving area of the upstream signal pressure Pps and a pressure receiving area of the downstream signal pressure Pls are constituted to be equal to each other. The pressure receiving area of the upstream signal pressure Pps corresponds to a sectional area of the first land portion 62 of the control spool 61 on which the upstream signal pressure Pps acts. The pressure receiving area of the downstream signal pressure Pls corresponds to a sectional area of the third piston portion 74 of the control piston 71 on which the downstream signal pressure Pls acts. That is, the sectional area of the first land portion 62 of the control spool 61 and the sectional area of the third piston portion 74 are formed so as to be equal to each other.

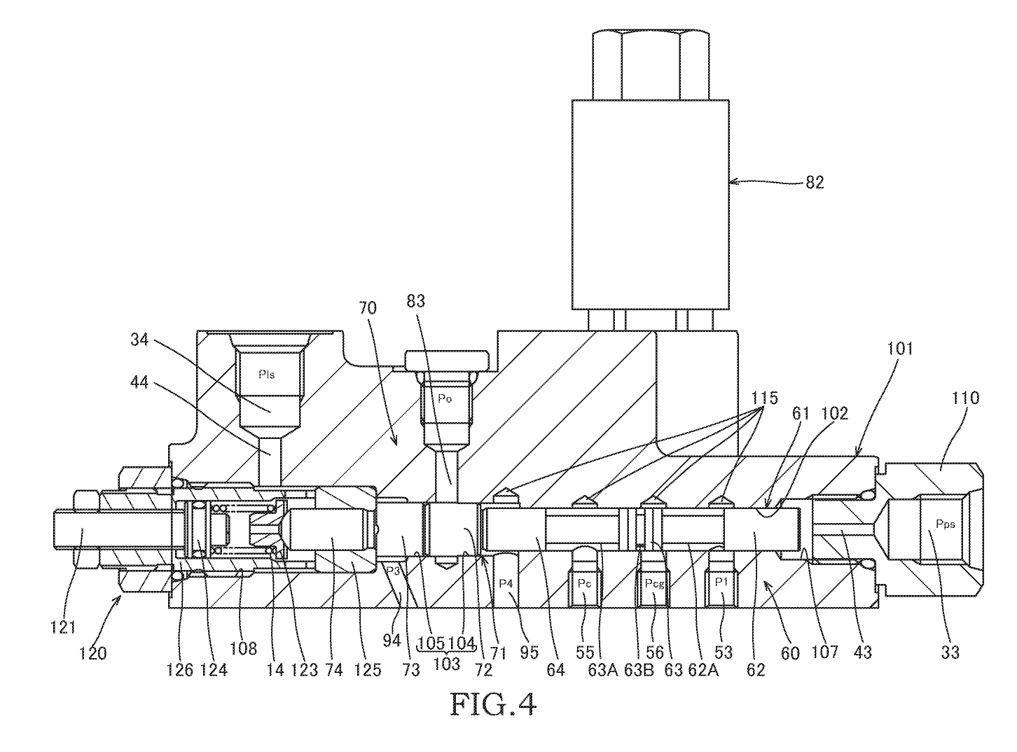

In a state where the LS differential pressure (Pps−Pls) between the upstream signal pressure Pps and the downstream signal pressure Pls is small, and the LS spring 14 is extended, as illustrated in FIG. 2, the second control pressure passage 56 communicates with the first control pressure passage 55 through the second annular groove 63A, and the communication with the third discharge pressure passage 53 is shut off by the second land portion 63 (the first position 60A). In a state where the LS differential pressure (Pps−Pls) is large, and the LS spring 14 is contracted, as illustrated in FIG. 4, the second control pressure passage 56 communicates with the third discharge pressure passage 53 through the first annular groove 62A, and the communication with the first control pressure passage 55 is shut off by the second land portion 63 (the second position 60B).

As illustrated in FIG. 3, the downstream pressure passage 95 is connected to the first pressure chamber 77. To the first pressure chamber 77, the downstream pressure P4 of the resistor 65 is led through the downstream pressure passage 95. The downstream pressure P4 led to the first pressure chamber 77 acts on the first piston portion 72 of the control piston 71 and exerts the driving force for moving the control piston 71 to the direction where the regulator 60 is switched to the second position 60B (the left direction in FIG. 1, the left direction in FIG. 3).

The upstream pressure passage 94 is connected to the second pressure chamber 78. The upstream pressure P3 of the resistor 65 is led to the second pressure chamber 78 through the upstream pressure passage 94. The upstream pressure P3 led to the second pressure chamber 78 acts on the second piston portion 73 of the control piston 71 and exerts the driving force for moving the control piston 71 to the direction where the regulator 60 is switched to the first position 60A (the right direction in FIG. 1, the right direction in FIG. 3).

The auxiliary passage 83 is connected to the third pressure chamber 79. The auxiliary pressure Po is selectively led to the third pressure chamber 79 through the auxiliary passage 83. When the switch valve 80 is at the communication position 80A, the auxiliary pressure Po is supplied to the third pressure chamber 79 through the auxiliary passage 83. When the switch valve 80 is at the shutoff position 80B, the supply of the auxiliary pressure Po to the third pressure chamber 79 through the auxiliary passage 83 is shut off, and the third pressure chamber 79 communicates with the tank.

The auxiliary pressure Po led to the third pressure chamber 79 acts on the piston stepped portion 75 and exerts the driving force for moving the control piston 71 to the direction where the regulator 60 is switched to the second position 60B (hereinafter referred to as an “auxiliary driving force”). That is, the auxiliary driving force is a driving force supplementing the driving force of the control piston 71 generated by the downstream pressure P4 of the resistor 65 and acting against the driving force of the control piston 71 generated by the upstream pressure P3 of the resistor 65. Thus, the auxiliary pressure Po acts on the control piston 71 so that the driving force generated by the front-rear differential pressure (P3−P4) of the resistor 65 (hereinafter referred to as a “differential-pressure driving force”) apparently becomes small.

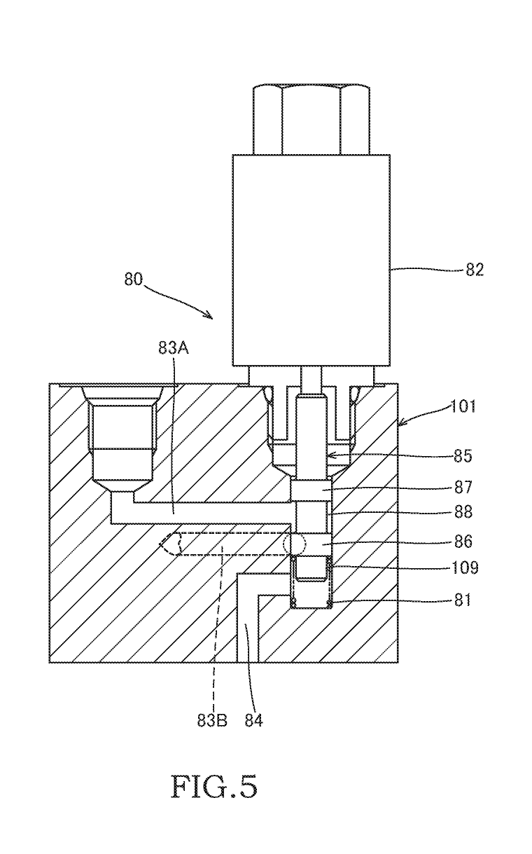

The switch valve 80 has, as illustrated in FIG. 5, a switching spool 85 for selectively switching between the communication position 80A and the shutoff position 80B, an biasing spring 81 for biasing the switching spool 85 so as to take the shutoff position 80B, and a solenoid 82 exerting the driving force against the biasing force of the biasing spring 81 by electric conduction.

In the housing 101, a switching spool hole 109 into which the switching spool 85 of the switch valve 80 is slidably inserted, a first communication passage 83A communicating with the switching spool hole 109 and leading the auxiliary pressure Po from outside of the pump device 100, a second communication passage 83B communicating with the switching spool hole 109 and communicating with the third pressure chamber 79, and a discharge passage 84 communicating with the switching spool hole 109 and leading the working oil to the tank port 30 (see FIG. 1) are further formed. The first communication passage 83A and the second communication passage 83B constitute a part of the auxiliary passage 83.

The switching spool 85 of the switch valve 80 has first and second switching land portions 86 and 87 sliding in the switching spool hole 109. In the switching spool 85, an annular groove 88 opened in the outer peripheral surface and formed between the first switching land portion 86 and the second switching land portion 87 is provided.

The biasing spring 81 is interposed between a bottom portion of the switching spool hole 109 and the switching spool 85 in a compressed state.

When an electric current is not supplied to the solenoid 82, as illustrated in FIG. 5, the switching spool 85 is biased by the biasing force of the biasing spring 81, and communication between the first communication passage 83A and the second communication passage 83B is shut off by the first switching land portion 86 (the shutoff position 80B).

When the electric current is supplied to the solenoid 82, the switching spool 85 is moved by the driving force of the solenoid 82 against biasing force of the biasing spring 81. As a result, the first communication passage 83A and the second communication passage 83B communicate with each other through the annular groove 88, and the auxiliary pressure is led to the third pressure chamber 79 (the communication position 80A).

Next, referring mainly to FIG. 1, actions of the pump device 100 will be described.

In the pump device 100, horsepower control for controlling the discharge capacity of the first pump 10 so as to maintain the discharge pressure P1 of the first pump 10 at a constant pressure is executed by the horsepower control regulator 40, load control (LS control) for controlling the discharge capacity of the first pump 10 so as to maintain the front-rear differential pressure (the LS differential pressure) of the control valve 3 at a constant pressure is executed by the regulator 60, and discharge flow control for controlling the discharge capacity of the first pump 10 in accordance with a pump rotation speed (an engine rotation speed) is executed.

In the pump device 100, the regulator 60 regulates the control pressure Pcg in accordance with the control source pressure Pc, which is regulated by the horsepower control regulator 40. Hence, in a condition where the discharge pressure P1 of the first pump 10 is maintained within a fixed range, the discharge capacity of the first pump 10 is controlled by load control rather than horsepower control. When the discharge pressure P1 exceeds the fixed range, the discharge capacity of the first pump 10 is controlled by horsepower control. Thus, the discharge capacity of the first pump 10 can be controlled by horsepower control to maintain the discharge pressure P1 of the first pump 10 within the fixed range, and at the same time, the discharge capacity of the first pump 10 can also be controlled by load control to maintain the LS differential pressure of the control valve 3 at a constant pressure.

The respective types of control will now be described more specifically.

First, the horsepower control executed by the horsepower control regulator 40 will be described.

When the discharge pressure P1 of the first pump 10 increases in response to an increase in the pump rotation speed such that the driving force generated by the discharge pressure P1 received by the spool of the horsepower control regulator 40 increases beyond the biasing force of the horsepower control springs 48, 49, the spool moves in the direction (the rightward direction in FIG. 1) for switching to the high pressure position 40A.

Accordingly, a communication opening (a communication flow passage area) between the first control pressure passage 55 and the first discharge pressure passage 51 increases, and as a result, the control source pressure Pc in the first control pressure passage 55 is increased by the discharge pressure P1 of the first pump 10, which is led through the first discharge pressure passage 55. When the control source pressure Pc led to the regulator 60 increases, the control pressure Pcg regulated by the regulator 60 increases, and as a result, the tilt actuator 15 drives the swash plate 11 of the first pump 10 such that the tilt angle thereof decreases. Hence, when the discharge pressure P1 of the first pump 10 increases, the discharge capacity of the first pump 10 decreases.

Conversely, when the discharge pressure P1 of the first pump 10 decreases in response to a reduction in the pump rotation speed such that the driving force generated by the discharge pressure P1 received by the spool of the horsepower control regulator 40 falls below the biasing force of the horsepower control springs 48, 49, the spool moves in the direction (the leftward direction in FIG. 1) for switching to the low pressure position 40B. Accordingly, the communication opening between the first control pressure passage 55 and the low pressure passage 59 increases, and as a result, the control source pressure Pc in the first control pressure passage 55 is reduced by the pressure in the low pressure passage 59 communicating with the tank. As a result, the control pressure Pcg regulated by the regulator 60 also decreases, whereby the tilt angle of the swash plate 11 is increased by the biasing force of the horsepower control springs 48, 49. Hence, when the discharge pressure P1 of the first pump 10 decreases, the discharge capacity of the first pump 10 increases.

As described above, the horsepower control regulator 40 regulates the control source pressure Pc led to the regulator 60 so that the driving force generated by the discharge pressure P1 and the biasing force of the horsepower control springs 48, 49 are counterbalanced. The horsepower control regulator 40 operates to increase the control pressure Pcg by increasing the control source pressure Pc in accordance with an increase in the discharge pressure P1 resulting from an increase in the pump rotation speed, and in so doing, reduces the discharge capacity of the first pump 10. Further, the horsepower control regulator 40 operates to reduce the control pressure Pcg by reducing the control source pressure Pc in accordance with a reduction in the discharge pressure P1 resulting from a reduction in the pump rotation speed, and in so doing, increases the discharge capacity of the first pump 10. In other words, when the pump rotation speed varies, the horsepower control regulator 40 varies the discharge capacity of the first pump 10 so as to cancel out variation in the discharge flow (the supply flow) of the first pump 10 resulting from the variation in the pump rotation speed. As a result, a load (a work rate) of the first pump 10 is regulated so as to remain substantially constant, irrespective of the pump rotation speed.

Next, the load control executed by the regulator 60 will be described.

When a load of the hydraulic cylinder 2 increases, the downstream signal pressure (a load pressure) Pls led to the signal port 34 from the downstream side (a load side) of the control valve 3 increases. When the LS differential pressure (Pps−Pls) decreases in response to the increase in the downstream signal pressure Pls, the control spool 61 of the regulator 60 is moved by the biasing force of the LS spring 14 in the direction for switching to the first position 60A.

As illustrated in FIG. 2, when the control spool 61 of the regulator 60 moves in the direction for switching to the first position 60A, the communication opening between the first control pressure passage 55 and the second control pressure passage 56 increases. Accordingly, the control pressure Pcg decreases on the basis of the control source pressure Pc, which is regulated by the horsepower control regulator 40 to be lower than the discharge pressure of the first pump 10. As a result, the tilt actuator 15 moves in a direction (the leftward direction in FIG. 1) for increasing the tilt angle of the swash plate 11, leading to an increase in the discharge capacity of the first pump 10. When the discharge capacity of the first pump 10 increases, the LS differential pressure (Pps−Pls) of the control valve 3 becomes larger.

Conversely, when the load of the hydraulic cylinder 2 decreases, the downstream signal pressure (the load pressure) Pls decreases. When the LS differential pressure (Pps−Pls) increases in response to the reduction in the downstream signal pressure Pls, the spool of the regulator 60 is moved against the biasing force of the LS spring 14 in the direction for switching to the second position 60B.

As illustrated in FIG. 4, when the control spool 61 of the regulator 60 moves in the direction for switching to the second position 60B, the communication opening between the third discharge pressure passage 53 and the second control pressure passage 56 increases. Accordingly, the control pressure Pcg increases on the basis of the discharge pressure P1 of the first pump 10, which is led through the third discharge pressure passage 53. As a result, the tilt actuator 15 moves in a direction (the rightward direction in FIG. 1) for reducing the tilt angle of the swash plate 11, leading to a reduction in the discharge capacity of the first pump 10. When the discharge capacity of the first pump 10 decreases, the LS differential pressure (Pps−Pls) of the control valve 3 becomes smaller.

Hence, the regulator 60 regulates the control pressure Pcg led to the tilt actuator 15 so that the LS differential pressure (Pps−Pls) and the biasing force of the LS spring 14 are counterbalanced. When the LS differential pressure (Pps−Pls) decreases, the regulator 60 operates to increase the LS differential pressure (Pps−Pls) by reducing the control pressure Pcg so as to increase the discharge capacity of the first pump 10. Further, when the LS differential pressure (Pps−Pls) increases, the regulator 60 operates to reduce the LS differential pressure (Pps−Pls) by increasing the control pressure Pcg so as to reduce the discharge capacity of the first pump 10. In other words, the regulator 60 controls the discharge capacity of the first pump 10 so that even when the load of the hydraulic cylinder 2 varies, the LS differential pressure (Pps−Pls) remains substantially constant.

Hence, as long as the opening (the position) of the control valve 3 remains constant, the hydraulic cylinder 2 can be driven at a constant speed, irrespective of the workload, and as a result, an improvement in the controllability of the hydraulic cylinder 2 can be achieved. In other words, a drive speed (the supply flow) of the hydraulic cylinder 2 can be controlled in accordance with the opening (the position) of the control valve 3 alone, and as a result, variation in the speed of the hydraulic cylinder 2 caused by variation in the workload can be prevented.

Next, discharge flow control based on the pump rotation speed will be described.

The discharge flow control is executed by driving the regulator 60 using the control actuator 70 in accordance with the front-rear differential pressure (P3−P4) of the resistor 65 to which the working oil discharged from the second pump 16 is led.

When the pump rotation speed (the engine rotation speed) decreases, the discharge flow of the second pump 16 decreases, leading to a reduction in the front-rear differential pressure (P3−P4) of the resistor 65. When the relief valve 67 is closed, leading to a reduction in the front-rear differential pressure (P3−P4) of the resistor 65, or in other words a relative increase in the downstream pressure P4 of the resistor 65, from a condition in which the force acting on the control actuator 70 is counterbalanced, the control actuator 70 moves in the direction (the leftward direction in FIG. 1) for switching the regulator 60 to the second position 60B. Accordingly, the communication opening between the third discharge pressure passage 53 and the second control pressure passage 56 increases such that the control pressure Pcg increases on the basis of the discharge pressure P1 of the first pump 10, which is led through the third discharge pressure passage 53. As a result, the tilt actuator 15 drives the swash plate 11 of the first pump 10 so as to reduce the tilt angle thereof, leading to a reduction in the discharge capacity of the first pump 10.

Conversely, when the pump rotation speed increases, the discharge flow of the second pump 16 increases, leading to an increase in the front-rear differential pressure (P3−P4) of the resistor 65. When the front-rear differential pressure (P3−P4) of the resistor 65 increases, or in other words when a relative increase occurs in the upstream pressure P3, from a condition in which the force acting on the control actuator 70 is counterbalanced, the control actuator 70 drives the control spool 61 of the regulator 60 in the direction (the rightward direction in FIG. 1) for switching to the first position 60A. Accordingly, the communication opening between the first control pressure passage 55 and the second control pressure passage 56 increases such that the control pressure Pcg led to the tilt actuator 15 decreases on the basis of the control source pressure Pc, which is regulated by the horsepower control regulator 40. As a result, the tilt actuator 15 drives the swash plate 11 of the first pump 10 so as to increase the tilt angle thereof, leading to an increase in the discharge capacity of the first pump 10.

As described above, the discharge flow of the first pump 10 is controlled to increase in proportion with an increase in the engine rotation speed.

Next, actions of the auxiliary passage 83 and the switch valve 80 will be described. In the following description, a condition in which the switch valve 80 is in the communication position 80A so that the auxiliary pressure Po is led into the third pressure chamber 79 of the control actuator 70 through the auxiliary passage 83 will be referred to as an “auxiliary pressure supply condition”, and a condition in which, conversely, the switch valve 80 is in the shutoff position 80B so that the auxiliary pressure Po is not led (i.e. is shut off) into the third pressure chamber 79 will be referred to as an “auxiliary pressure shutoff condition”.

The auxiliary pressure Po led through the auxiliary passage 83 is supplied to the third pressure chamber 79 of the control actuator 70 in order to generate auxiliary driving force for resisting the upstream pressure P3 of the resistor 65 with respect to the piston stepped portion 75 and the rod 76 of the control actuator 70. In other words, the auxiliary pressure Po acts on the control piston 71 of the control actuator 70 so as to supplement the downstream pressure P4 of the resistor 65, and therefore apparently acts to reduce the front-rear differential pressure (P3−P4) of the resistor 65.

In the auxiliary pressure supply condition, therefore, the control pressure Pcg led to the tilt actuator 15 increases such that, the discharge flow of the first pump 10 is smaller than in the auxiliary pressure shutoff condition at an identical pump rotation speed. Conversely, in the auxiliary pressure shutoff condition, the control pressure Pcg is smaller than in the auxiliary pressure supply condition, and as a result, the discharge flow of the first pump 10 increases.

In the pump device 100, the controller 90 switches the position of the switch valve 80 and modifies the rotation speed of the engine 4 in response to operation input from the operator.

More specifically, the controller 90 switches an operation of the pump device 100 between two control conditions, namely a “normal mode” and an “energy saving mode”, by varying the engine rotation speed in accordance with the switch executed on the switch valve 80 on the basis of operation input from the operator.

In the normal mode, the engine rotation speed is maintained at a relatively high first rotation speed, and the switch valve 80 is switched to the communication position 80A. In the normal mode, the auxiliary pressure Po is led to the control actuator 70 so that the discharge capacity of the first pump 10 is set to be relatively small.

In the energy saving mode, the engine rotation speed is maintained by the controller 90 at a second rotation speed lower than the first rotation speed, and the switch valve 80 is switched to the shutoff position 80B, and the supply of the auxiliary pressure Po to the control actuator 70 is shut off.

In the pump device 100, an area of the piston stepped portion 75 which is a pressure receiving area of the auxiliary pressure Po is set so that the auxiliary driving force corresponds to a lowered amount of the differential-pressure driving force accompanying switching of the engine rotation speed. In more detail, when the engine rotation speed is switched from the first rotation speed to the second rotation speed, the discharge flow of the second pump 16 lowers, and the differential-pressure driving force lowers. The auxiliary driving force is a driving force acting in a direction against the differential-pressure driving force. Thus, by shutting off the supply of the auxiliary pressure Po at the same time as the engine rotation speed is switched from the first rotation speed to the second rotation speed, the auxiliary driving force stops acting with lowering of the differential-pressure driving force and thus, a change in the position of the control spool 61 rarely occurs. As a result, in the energy-saving mode, the supply flow to the hydraulic cylinder 2 can be maintained at a flow to the same degree as that in the normal mode.

Hence, in the energy saving mode, an identical discharge flow (supply flow) to that of the normal mode can be secured even though the engine rotation speed is lower than in the normal mode, and therefore an equal driving speed to that of the normal mode can be realized. As a result, the energy consumption of the pump device 100 can be suppressed.

Conversely, in the normal mode, the rate at which the discharge flow varies relative to the pump rotation speed is smaller than in the energy-saving mode, and therefore the discharge flow can be adjusted easily by modifying the engine rotation speed. Hence, in the normal mode, the supply flow to the hydraulic cylinder 2 can be adjusted with a high degree of precision.

Moreover, if the engine rotation speed lowers while the switch valve 80 is maintained at the communication position 80A (still in the normal mode), the discharge flow of the second pump 16 is reduced by the lowering of the engine rotation speed, and the front-rear differential pressure (P3−P4) of the resistor 65 lowers. When the front-rear differential pressure (P3−P4) of the resistor 65 lowers from the state where the force acting on the control actuator 70 is balanced, the control actuator 70 is moved to the direction (left direction in FIG. 1) where the regulator 60 is switched to the second position 60B. Thus, the control pressure Pcg is raised on the basis of the discharge pressure P1 of the first pump 10 led through the third discharge pressure passage 53, and the tilting actuator 15 drives the swash plate 11 of the first pump 10 so that the tilting angle is reduced. Therefore, since the discharge capacity of the first pump 10 is reduced by the lowering of the engine rotation speed, the driving speed of the hydraulic cylinder 2 lowers in accordance with the engine rotation speed.

As described above, in the pump device 100, whether the driving force of the control actuator 70 is maintained or is lowered with lowering of the engine rotation speed can be switched in accordance with the operation input of the worker. Therefore, in the pump device 100, the change rate of the discharge flow with respect to the change in the rotation speed can be changed.

Subsequently, a variation of this embodiment will be described. The variations as follows are also within the range of the present invention, and it is possible to combine the configuration illustrated in the variation and each configuration described in the aforementioned embodiment, to combine the configurations described in the different embodiments or to combine the following variations with each other.

In the above embodiment, the auxiliary pressure Po acts against the upstream pressure P3 of the resistor 65, thereby acting apparently to reduce the front-rear differential pressure (P3−P4) of the resistor 65. Instead, however, the auxiliary pressure Po may act against the downstream pressure P4 of the resistor 65, or in other words act to supplement the upstream pressure P3, thereby acting apparently to increase the front-rear differential pressure (P3−P4). Likewise in this case, by switching between supplying and shutting off the auxiliary pressure Po using the switch valve 80, the control pressure Pcg regulated by the regulator 60 can be varied, and as a result, the discharge flow of the first pump 10 can be varied while the load remains constant.

Further, in the above embodiment, in the energy-saving mode, the rotation speed of the engine 4 is reduced and supply of the auxiliary pressure Po that acts against the upstream pressure P3 of the resistor 65 is shut off. On the other hand, on the basis of operation input from the operator, the rotation speed of the engine 4 may be increased or reduced, the auxiliary pressure Po may be set to act against the upstream pressure P3 or the downstream pressure P4 of the resistor 65, and the auxiliary pressure Po may be supplied or shut off when the rotation speed of the engine 4 varies (increases or decreases). Moreover, these configurations may be combined as desired. For example, the pump device 100 may be configured such that when the rotation speed of the engine 4 decreases, the auxiliary pressure Po is supplied against the downstream pressure P4 of the resistor 65. In this case, identical actions and effects to those of the energy-saving mode described above are obtained. Hence, variation in the rotation speed of the engine 4, switching of the auxiliary pressure Po, and the direction in which the auxiliary pressure Po acts may be set as desired in accordance with requirements.

Further, in the above embodiment, the switch valve 80 is an ON-OFF valve for selectively switching between connecting and shutting off the auxiliary passage 83. Instead, however, the switch valve 80 may be a proportional solenoid valve that controls the magnitude of the auxiliary pressure Po led to the control actuator 70 by opening the auxiliary passage 83 by a communication opening (a communication flow passage area) corresponding to an energization amount applied to the solenoid 82. In this case, for example, the controller 90 may obtain the engine rotation speed and energize the solenoid 82 of the switch valve 80 by an energization amount corresponding to the engine rotation speed. By configuring the pump device 100 in this manner, the speed of the hydraulic cylinder 2 can be controlled in accordance with variation in the engine rotation speed.

According to the aforementioned embodiment, the following effects are exerted.

In the pump device 100, by switching the switch valve 80 so that the supply of the auxiliary pressure Po to the control actuator 70 is shut off with lowering of the engine rotation speed, the differential-pressure driving force is lowered by lowering of the engine rotation speed, and the auxiliary driving force acting so as to resist the differential-pressure driving force does not act any more. Thus, a change is not generated in the driving amount of the regulator 60 by the control actuator 70 from before to after the switching of the switch valve 80, and the tilting angle of the swash plate 11 is not changed. Thus, even if the engine rotation speed changes, the discharge flow of the first pump 10 barely changes. Moreover, by switching the switch valve 80 so that the auxiliary pressure Po is supplied to the control actuator 70 with lowering of the engine rotation speed, due to lowering of the differential-pressure driving force based on the lowering of the engine rotation speed, the control actuator 70 drives the regulator 60 so that the control pressure Pcg rises, and the tilting angle of the swash plate 11 becomes smaller. As described above, in the pump device 100, to maintain or to lower the driving force of the control actuator 70 can be switched with lowering of the engine rotation speed. Therefore, in the pump device 100, the change rate of the discharge flow with respect to the change in the rotation speed can be changed.

Moreover, in the pump device 100, since the opposing holes 115 are formed at positions opposing the openings of the introduction passages 53, 55, 56, and 95, a pressure balance of the working oil acting on the control spool. 61 is kept, and slidability of the control spool 61 can be made favorable.

### Second Embodiment

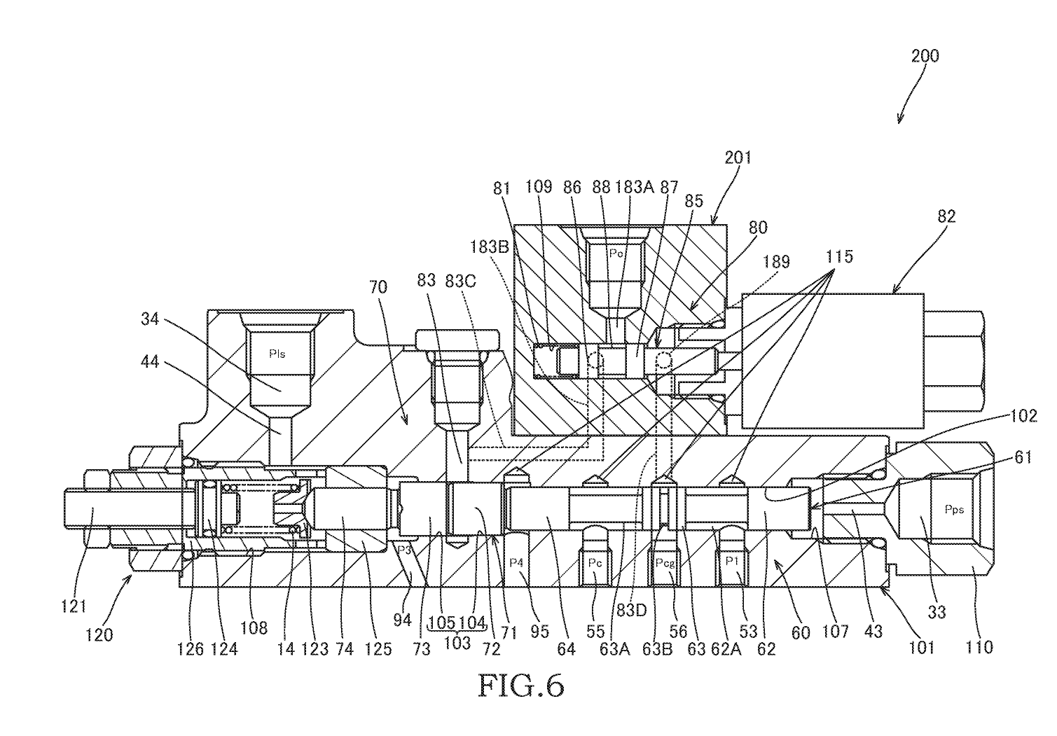

Subsequently, by referring to FIG. 6, a pump device 200 according to a second embodiment of the present invention will be described.

In the aforementioned embodiment, the regulator 60, the control actuator 70, and the switch valve 80 are provided in the common housing 101, respectively. On the other hand, in the pump device 200, as illustrated in FIG. 6, the switch valve 80 is accommodated in a valve housing 201 detachably attached to the housing 101 accommodating the control spool 61 of the regulator 60.

The pump device 200 further includes the valve housing 201 detachably attached to the housing 101 for accommodating the control spool 61 of the regulator 60 and accommodating the switch valve 80. The valve housing 201 is detachably attached to the housing 101 by a bolt (not shown). The solenoid 82 is attached to the valve housing 201.

In the valve housing 201, the switching spool hole 109, a first communication passage 183A opened in a surface of the valve housing 201, communicating with the switching spool hole 109, and leading the auxiliary pressure Po from outside of the pump device 200, a second communication passage 183B communicating with the switching spool hole 109 and leading the auxiliary pressure to the third pressure chamber 79, and a discharge passage 189 communicating with the switching spool hole 109 and communicating with the tank are formed.

In the housing 101, a connection passage 83C connecting the first communication passage 183A of the valve housing 201 and the third pressure chamber 79 and a tank connection passage 83D connecting the discharge passage 189 and the tank port 30 are further formed. When the switch valve 80 is at the communication position 80A as illustrated in FIG. 6, the auxiliary pressure Po is led to the third pressure chamber 79 through the first communication passage 183A, the switching spool hole 109, the second communication passage 183B, and the connection passage 83C. When the switch valve 80 is at the shutoff position 80B, the auxiliary pressure Po is led to the tank port 30 through the first communication passage 183A, the switching spool hole 109, the discharge passage 189, and the tank connection passage 83D.

As described above, since the valve housing 201 accommodating the switch valve 80 is provided as a separately body from the housing 101, the layout freedom of the switch valve 80, the first communication passage 183A, the second communication passage 183B, and the auxiliary passage 83 with respect to the regulator 60 can be improved. For example, by using the valve housing 201 with different layout of the switching spool hole 109 to be formed or the like, a direction of the solenoid 82 can be arbitrarily set in accordance with the hydraulic excavator on which the pump device 200 is to be mounted. As a result, lowering of the driving force of the solenoid 82 for driving the switching spool 85 due to an influence of a gravitational force caused by arranging a center axis of the switching spool 85 along the vertical direction can be prevented.

Moreover, in addition to the fact that the solenoid 82 can be arranged at an arbitrary position, the first communication passage 183A and the second communication passage 183B formed in the valve housing 201 can be laid out at arbitrary positions and thus, a hydraulic pipeline for leading the auxiliary pressure Po from outside of the pump device 200 and a hydraulic pipeline connected to the signal ports 33 and 34 for leading the upstream signal pressure Pps and the downstream signal pressure Pls of the control valve 3, respectively can be also laid out arbitrarily. As a result, the pump device 200 can be easily installed in a place where an installation space is limited such as in an engine room.

According to the aforementioned second embodiment, the effects similar to those of the first embodiment are exerted and the following effects are also exerted.

In the pump device 200, since the switch valve 80 is provided in the valve housing 201 which is a separate body from the housing 101, the layout freedom of the solenoid 82 and the auxiliary passage 83, the first communication passage 183A, and the second communication passage 183B for leading the auxiliary pressure Po is improved. Thus, the driving direction of the solenoid 82 can be prevented from being directed to the vertical direction, and the layout freedom of the hydraulic pipelines is improved, and mountability of the pump device 200 on the hydraulic excavator or the like can be improved.

Constitutions, actions, and effects of the embodiments of present invention will be described below collectively.

The pump device 100, 200 for supplying the working oil to the hydraulic cylinder 2 for driving the driving subject through the control valve 3 includes a variable capacity first pump 10 that supplies the working oil to the hydraulic cylinder 2, the first pump 10 having a discharge capacity that varies in accordance with the tilting angle of the swash plate 11, the tilting actuator 15 that controls the tilting angle of the swash plate 11 in the first pump 10 in accordance with the supplied control pressure Pcg, the regulator 60 that adjusts the control pressure Pcg by the control spool 61 moving in accordance with the front-rear differential pressure (LS differential pressure) between the pressure Pps on the upstream side and the pressure Pls on the downstream side of the control valve 3, the fixed capacity second pump 16 driven by the identical drive source (engine 4) of the first pump 10, the resistor 65 provided in the pump passage 24 through which the working oil discharged from the second pump 16 is led, the control actuator 70 that operates in accordance with the front-rear differential pressure (P3−P4) of the resistor 65 so as to drive the regulator 60 to reduce the control pressure Pcg in response to an increase in the front-rear differential pressure (P3−P4) of the resistor 65, the auxiliary passage 83 for leading the auxiliary pressure Po to the control actuator 70, the auxiliary pressure Po acting on the control actuator 70 against either the upstream pressure P3 or the downstream pressure P4 of the resistor 65, the switch valve 80 for switching between a state in which the auxiliary pressure Po is supplied to the control actuator 70 through the auxiliary passage 83 and a state in which the auxiliary pressure Po is shut off of the auxiliary pressure Po to, and the controller 90 for switching the switch valve 80 and switching the rotation speed of the drive source (engine 4) between the first rotation speed and the second rotation speed smaller than the first rotation speed, in which the control actuator 70 has the control piston 71 moved so that the differential-pressure driving force generated by receiving the front-rear differential pressure of the resistor 65 and the auxiliary driving force generated by receiving the auxiliary pressure Po are balanced, and the pressure receiving area of the control piston 71 on which the auxiliary pressure Po acts is set so that the auxiliary driving force corresponds to the change amount of the differential-pressure driving force accompanying switching of the rotation speed of the drive source (engine 4) between the first rotation speed and the second rotation speed.

In this constitution, when the rotation speed of the drive source (engine 4) is changed, the discharge flow of the second pump 16 is changed, and the differential-pressure driving force exerted by the front-rear differential pressure (P3−P4) of the resistor 65 is changed. On the other hand, when the supply and shut-off of the auxiliary pressure Po to the control actuator 70 is switched, whether or not the auxiliary driving force is made to act on the control actuator 70 is switched. Moreover, the pressure receiving area of the auxiliary pressure Po in the control piston 71 is set so as to exert the auxiliary driving force corresponding to the change amount of the differential-pressure driving force caused by the change in the rotation speed of the drive source (engine 4). Thus, by switching between the supply and the shut-off of the auxiliary pressure Po at a change of the rotation speed of the drive source (engine 4), to change the driving force of the control actuator 70 or to maintain it with lowering of the rotation speed of the drive source (engine 4) can be switched. Therefore, in the pump device 100, 200, the change rate of the discharge flow with respect to the change in the rotation speed can be changed.

Moreover, in the pump device 100, 200, the regulator 60 further includes the housing 101 for accommodating the control spool 61, the spool hole 102, he introduction passage (the third discharge pressure passage 53, the first control pressure passage 55, the second control pressure passage 56, and the downstream pressure passage 95), and the opposing hole 115 are formed in the housing 101, the control spool 61 is movably inserted into the spool hole 102 in the axial direction, the introduction passage (the third discharge pressure passage 53, the first control pressure passage 55, the second control pressure passage 56, and the downstream pressure passage 95) is opened in the spool hole 102 from the radial direction and leads the working fluid to the spool hole 102, and the opposing hole 115 is opened at a position opposing the opening of the introduction passage (the third discharge pressure passage 53, the first control pressure passage 55, the second control pressure passage 56, and the downstream pressure passage 95) by sandwiching the center of the spool hole 102 between them.

Moreover, in the pump device 100, 200, the control spool 61 has the annular groove (the first annular groove 62A, the second annular groove 63A, and the third annular groove 63B) for leading the working oil from the introduction passage (the third discharge pressure passage 53, the first control pressure passage 55, the second control pressure passage 56, and the downstream pressure passage 95), and the opposing hole 115 is formed so as to face the annular groove (the first annular groove 62A, the second annular groove 63A, and the third annular groove 63B) regardless of the position of the control spool 61.

In this constitution, the pressure balance of the working oil acting on the control spool 61 is kept favorable. Therefore, slidability of the control spool 61 can be made favorable.

Moreover, the pump device 200 further includes the valve housing 201 detachably attached to the housing 101 for accommodating the control spool 61 of the regulator 60 and accommodating the switch valve 80.

In this constitution, since the degree of layout freedom of the switch valve 80 is improved, the driving direction of the switch valve 80 can be prevented from matching with the vertical direction.

Moreover, in the pump device 100, 200, in the control spool 61, the pressure receiving area on which the pressure Pps on the upstream side of the control valve 3 acts and the pressure receiving area on which the pressure Pls on the downstream side acts are set so as to be equal to each other.

Moreover, in the pump device 100, 200, the auxiliary pressure Po acts on the control actuator 70 so as to resist the upstream pressure P3 of the resistor 65, and the pressure receiving area of the control piston 71 on which the auxiliary pressure Po acts is set so that the auxiliary driving force corresponds to the lowered amount of the differential-pressure driving force accompanying switching of the rotation speed of the drive source (engine 4) from the first rotation speed to the second rotation speed.

In this constitution, by means of lowering of the discharge flow of the second pump 16 caused by lowering of the rotation speed of the drive source (engine 4), the differential-pressure driving force exerted by the front-rear differential pressure of the resistor 65 lowers. By switching the switch valve 80 so that the supply of the auxiliary pressure Po to the control actuator 70 is shut off with the lowering of the rotation speed of the drive source (engine 4), the differential-pressure driving force lowers by the lowering of the rotation speed of the drive source (engine 4), and the auxiliary driving force acting against the differential-pressure driving force does not act any more. Thus, a change is not generated in the driving amount of the regulator 60 by the control actuator 70 from before to after the switching of the switch valve 80, and the tilting angle of the swash plate 11 is not changed. Thus, even if the rotation speed of the drive source (engine 4) changes, the discharge flow of the first pump 10 barely changes. Moreover, by switching the switch valve 80 so that the auxiliary pressure Po is supplied to the control actuator 70 with lowering of the rotation speed of the drive source (engine 4), due to lowering of the differential-pressure driving force based on the lowering of the rotation speed of the drive source (engine 4), the control actuator 70 drives the regulator 60 so that the control pressure Pcg rises, and the tilting angle of the swash plate 11 becomes smaller. As described above, in the pump device 100, to maintain or to lower the driving force of the control actuator 70 can be switched with lowering of the rotation speed of the drive source (engine 4). Therefore, in the pump device 100, 200, the change rate of the discharge flow with respect to the change in the rotation speed can be changed.

Embodiments of this invention were described above, but the above embodiments are merely examples of applications of this invention, and the technical scope of this invention is not limited to the specific constitutions of the above embodiments.

This application claims priority based on Japanese Patent Application No. 2016-114427 filed with the Japan Patent Office on Jun. 8, 2016, the entire contents of which are incorporated into this specification.

1. A pump device for supplying a working fluid to a drive actuator for driving a drive subject through a control valve, comprising:
a variable capacity first pump configured to supply the working fluid to the drive actuator, the first pump having a discharge capacity that varies in accordance with a tilt angle of a swash plate;
a tilt actuator configured to control the tilt angle of the swash plate of the first pump in accordance with a control pressure supplied thereto;
a regulator configured to regulate the control pressure by a control spool moving in accordance with a front-rear differential pressure on an upstream side and a pressure on a downstream side of the control valve;
a fixed capacity second pump configured to be driven by an identical drive source to that of the first pump;
a resistor provided in a pump passage through which the working fluid discharged from the second pump is led;
a control actuator configured to operate in accordance with a front-rear differential pressure of the resistor so as to drive the regulator to reduce the control pressure in response to an increase in the front-rear differential pressure of the resistor;
an auxiliary passage configured to lead an auxiliary pressure to the control actuator, the auxiliary pressure acting on the control actuator against either an upstream side pressure or a downstream side pressure of the resistor;
a switch valve configured to switch between a state in which the auxiliary pressure is supplied to the control actuator through the auxiliary passage and a state in which the auxiliary pressure is shut off; and
a controller configured to switch the switch valve and to switch a rotation speed of the drive source between a first rotation speed and a second rotation speed smaller than the first rotation speed, wherein
the control actuator has a control piston configured to be moved so that a differential-pressure driving force generated by receiving the front-rear differential pressure of the resistor and an auxiliary driving force generated by receiving the auxiliary pressure are balanced; and
a pressure receiving area of the control piston on which the auxiliary pressure acts is set so that the auxiliary driving force corresponds to a change amount of the differential-pressure driving force accompanying switching of the rotation speed of the drive source between the first rotation speed and the second rotation speed.

2. The pump device according to claim 1, wherein
the regulator further includes a housing adapted to accommodate the control spool;
a spool hole, an introduction passage, and an opposing hole are formed in the housing,
the spool hole into which the control spool is movably inserted into the spool hole in an axial direction;
the introduction passage is opened in the spool hole from a radial direction and configured to lead the working fluid to the spool hole; and
the opposing hole is opened at a position opposing the opening of the introduction passage by sandwiching a center of the spool hole are formed.

3. The pump device according to claim 2, wherein
the control spool has an annular groove configured to lead the working fluid from the introduction passage; and
the opposing hole is formed by facing the annular groove regardless of the position of the control spool.

4. The pump device according to claim 1, further comprising:
a valve housing detachably attached to a housing configured to accommodate the control spool of the regulator, the valve housing accommodating the switch valve.

5. The pump device according to claim 1, wherein
in the control spool, a pressure receiving area on which a pressure on the upstream side of the control valve acts and a pressure receiving area on which the pressure on the downstream side acts are set equal to each other.

6. The pump device according to claim 1, wherein
the control piston is configured such that the auxiliary pressure acts on the control piston against the upstream side pressure of the resistor; and
the pressure receiving area of the control piston on which the auxiliary pressure acts is set so that the auxiliary driving force corresponds to a lowered amount of the differential-pressure driving force accompanying switching of the rotation speed of the drive source from the first rotation speed to the second rotation speed.
